(19) United States
(12) Patent Application Publication
(10) Pub. No.: US 2026/0265449 A1
(43) Pub. Date: Sep. 10, 2026

(54) RING-OPENING METATHESIS POLYMERIZATION CATALYSTS, COMPOSITIONS AND METHODS

(71) Applicant: RapiCure Solutions, Inc., Loveland, CO (US)

(72) Inventors: Heather RUBIN, Loveland, CO (US); Ercan BAYRAM, Loveland, CO (US); Robert TUTTLE, Loveland, CO (US); Marina BLOOD, Loveland, CO (US); Chelsea DUCOTE, Loveland, CO (US); Elisabeth KULESUS, Loveland, CO (US); Hannah LELOUP, Loveland, CO (US); Gerald WILSON, Champaign, IL (US); Sai Srivatsa KUMAR, Champaign, IL (US); Steven C. HANSEN, Champaign, IL (US); Ian VETTER, Champaign, IL (US)

(21) Appl. No.: 19/560,001

(22) Filed: Mar. 7, 2026

Related U.S. Application Data
(60) Provisional application No. 63/768,920, filed on Mar. 8, 2025.

(51) Int. Cl. C08G 61/08

(52) U.S. Cl. CPC C08G 61/08; C08G 2150/00; C08G 2261/316; C08G 2261/418

(57) ABSTRACT

Compositions comprising latent pre-catalysts, optionally within resins and composites, are disclosed. The resins and composites can be stored in an uncured state for an extended period before being activated by an external stimulus that initiates a self-propagating reaction front. Additionally, methods of producing latent-catalysts, resins and composites and using the materials for structural reinforcement and other applications are disclosed.

### CROSS-REFERENCE TO RELATED APPLICATIONS

This application claims the benefit of and priority to U.S. Provisional Patent Application No. 63/768,920, filed Mar. 8, 2025, which is hereby incorporated by reference in its entirety.

### STATEMENT REGARDING FEDERALLY SPONSORED RESEARCH

This invention was made with government support under Award No. REPAIR DE-AR0001330 awarded by the Advanced Research Projects Agency—Energy (ARPA-E), U.S. Department of Energy and Agreement No. 693JK32410015POTA awarded by the U.S. Department of Transportation, PHMSA. The Government has certain rights in the invention.

### BACKGROUND

First generation Grubbs catalysts (GC1s) were reported in 1995, and quickly adopted by the chemical industry for a wide variety of olefin metathesis reactions. Soon after, multiple generations of the ruthenium carbene-based catalysts followed. Second generation Grubbs catalysts (GC2s) provided higher activity than the first generation, and third generation Grubbs catalysts (GC3s) used highly labile ligands to provide faster-initiation than earlier generations.

On the other end of the spectrum, Hoveyda-Grubbs second-generation (HG2) catalysts used bidentate carbene ligands or sterically bulky phosphite ligands to achieve greater catalyst stability and slower initiation. Some of the HG2 catalysts were so stable that they required an external stimulus to transform into their active form, putting them in the category of latent pre-catalysts.

“Latent pre-catalysts” are a class of molecules/complexes that allow a user to control the timing of reaction onset. In the context of polymerization, this characteristic is especially helpful for applications that require resin manipulation prior to curing. However, this class of catalysts/pre-catalysts has a number of drawbacks relating to thin film formation, operating at large scale, and premature quenching of the hardening process in challenging environmental conditions.

### SUMMARY

Here, to overcome the limitations discussed above, compositions comprising latent pre-catalysts, optionally within resins and composites, are disclosed. The resins and composites can be stored in an uncured state for an extended period before being activated at a desired time by an external stimulus that initiates a self-propagating reaction front. Additionally, methods of producing latent-catalysts, resins and composites, and using the materials for structural reinforcement and other applications are disclosed.

In an aspect, a latent pre-catalyst has the formula:

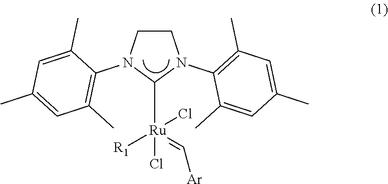

where R₁ is a phenoxy group optionally substituted with one or more substituents selected from —H, —OH, (1-6C)alkyl, halogen, thiol or nitro; and Ar is an aryl group. For example, R₁ may be a radical of a phenol, a bisphenol, a benezediol, a catechol, eugenol, vanillin, butylated hydroxytoluene, (4-tert-butyl)phenol, (4-tert-butyl)catechol, 2,2′-dihydroxybiphenyl, 4-methylcatechol or a combination thereof.

In an embodiment, the Ar group is optionally substituted with one or more substituents selected from (1-6C)alkoxyl, (1-6C)alkyl, aryl, (1-6C)alkylthio, halogen or nitro.

In an embodiment, the Ar group is selected from the group consisting of phenyl or indenyl, which may be optionally substituted with one or more substituents selected from (1-6C)alkoxyl, (1-6C)alkyl, aryl, (1-6C)alkylthio, halogen or nitro.

In an embodiment, a latent pre-catalyst exists in the absence of a phosphite ligand (i.e., does not comprise a phosphite ligand).

In an embodiment, a latent pre-catalyst is combined with a resin comprising a cyclic polyolefin susceptible to metathesis polymerization including ring-opening metathesis polymerization (ROMP), where the ROMP may be frontal ring-opening metathesis polymerization (FROMP).

In an embodiment, a latent pre-catalyst exists in the presence of an aryl phosphite selected from the group consisting of:

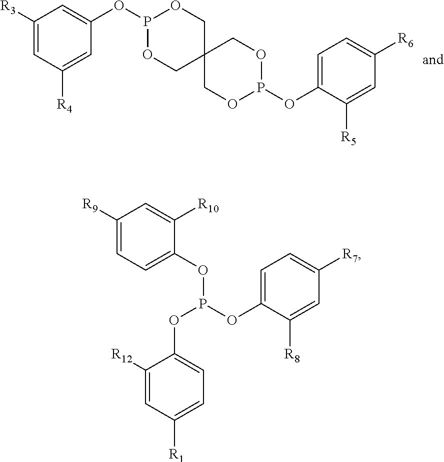

where R₃-R₁₂ are independently selected from —H and (1-1° C.)alkyl.

In an aspect, a method for making a latent pre-catalyst comprises combining [1,3-bis-(2,4,6-trimethylphenyl)-2-imidazolidinylidene]dichloro(phenylmethylene)(tricyclohexylphosphino)ruthenium(II) (GC2) and an R₁ ligand in an organic solvent selected from the group consisting of naphthalene, a substituted naphthalene derivative, an ester, a terpene, a terpene derivative and a combination thereof. Exemplary esters include, but are not limited to, acetates (e.g., benzyl acetate, geranyl acetate, cinnamyl acetate, cis-3-nononyl acetate, butyl phenylacetate, allyl acetate, 2-phenylethyl acetate), benzoates (e.g., phenylethyl benzoate, benzyl benzoate) and combinations thereof.

In an aspect, a method for making a latent pre-catalyst comprises grinding together solid forms of [1,3-bis-(2,4,6-trimethylphenyl)-2-imidazolidinylidene]dichloro(phenylmethylene)(tricyclohexylphosphino)ruthenium(II) (GC2) and an R₁ ligand.

In an aspect, a method for synthesizing a polymer comprises creating a mixture of a latent pre-catalyst disclosed herein, an aryl phosphite, and a cyclic polyolefin and applying energy to the mixture to initiate ring-opening metathesis polymerization (ROMP).

In an embodiment, the method further comprises discontinuing the step of applying energy after the ROMP is initiated.

In an embodiment, a mixture comprises a latent pre-catalyst disclosed herein, a cyclic polyolefin, an aryl phosphite, and optionally: one or more hydrocarbon polymers, one or more solid additives, one or more solid or liquid dyes or pigments, a defoamer, a polymer additive, and/or one or more organic solvents.

In an embodiment, the percentage by weight of the one or more hydrocarbon polymers in the resin mixture is at least 0.01, and the molecular weight of the one or more hydrocarbons is at least 2,000 g/mol.

In an embodiment, the percentage by weight of the solid additive or additives in the resin mixture is at least 0.01, and the solid additive is selected from the group consisting of a silica, silicate, aluminosilicate, solid or liquid pigment or dye, clay, or combination thereof. For example, a dye or pigment may be selected from the group consisting of inorganic pigment, carbon black, mica, mineral fillers, soluble dyes, chrome oxide, fluorescents and phosphorescents, iron oxides, microspheres, organic pigments, titanium dioxide, zinc oxide, zinc phosphate and combinations thereof.

In an embodiment, the defoamer is a silicon-based defoamer or a non-silicone, mineral oil or polymer-based defoamer, or a combination thereof. Exemplary defoamers include, but are not limited to, wax, non-silicone, silicane, non-ionic surfactants.

In an embodiment, the one or more organic solvents comprises naphthalene, a substituted naphthalene derivative, an ester, a terpene or terpene derivative, or a combination thereof.

In an embodiment, the polymer additive includes dispersing agents.

In an embodiment, a latent pre-catalyst and cyclic olefin mixture is used to form prepreg. For example, the resin mixture may be fully mixed, infused into a reinforcing fabric and stored at or below 25° C. for 7 days or more (e.g., 30 days, 60 days, 90 days, 180 days or 365 days), wherein after storage ring-opening metathesis polymerization or frontal ring-opening metathesis polymerization activity is retained. In an embodiment, the prepreg can be cut while frozen without cracking.

In an embodiment, a mixture forms a resin with a viscosity from 6 to 1,000,000 cP, or between 6 and 500,000 cP, or between 8 and 250,000 cP, or between 10 and 100,000 cP, or between 12 and 50,000 cP, or between 15 and 20,000 cP, or between 18 and 10,000 cP, or between 20 and 5,000 cP, or between 25 and 1,000 cP.

In an embodiment, a latent pre-catalyst comprises 0.01-100 molar equivalents of R₁ ligand relative to ruthenium, the aryl phosphite is present at a concentration of 0.01-100 molar equivalents relative to ruthenium, and the latent pre-catalyst is present at a concentration between 0.00001-1 molar equivalents of the cyclic polyolefin.

In an embodiment, the energy is heat, electromagnetic radiation, ultrasonic energy, or a combination thereof. In an embodiment, the electromagnetic radiation is ultraviolet light.

In an embodiment, the mixture has an initial viscosity between 6 and 1,000,000 cP.

In an embodiment, a time for the initial viscosity of the mixture to double is between 0.01 and 8 hours.

In an embodiment, the aryl phosphite is selected from the group consisting of:

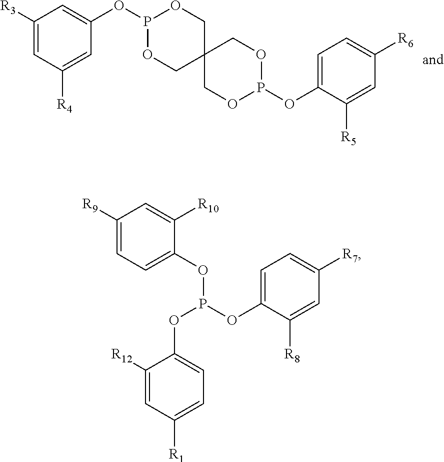

where R₃-R₁₂ are independently selected from —H and (1-10C)alkyl.

In an embodiment, the ROMP is a frontal ring-opening metathesis polymerization (FROMP) reaction. In an embodiment, the FROMP propagates a self-sustaining exothermic polymerization wave with a frontal velocity between 0.02 and 0.5 centimeters per second.

In an embodiment, a frontal polymerization temperature is between 60 and 250 degrees Celsius.

In an embodiment, a time required for the ROMP to initiate is between 1 and 2400 seconds.

In an embodiment, the cyclic polyolefin is selected from the group consisting of dicyclopentadiene, a substituted derivative of dicyclopentadiene, a cyclopentadiene oligomer of n=3 or greater, a norbornene, a substituted derivative of norbornene and a combination thereof.

In an embodiment, the step of applying energy is performed in an environment having a relative humidity of at least 80%. In an embodiment, the step of applying energy is performed in an underwater environment.

In an embodiment, the polymer thickness is between 0.001 and 2 inches thick, or between 0.001 and 1 inch thick, or between 0.01 and 1 inch thick, or between 0.05 and 0.5 inches thick. In an embodiment, the polymer is a free-standing thin film.

In an embodiment, a method for synthesizing a polymer further comprises using heat, electromagnetic radiation and/or ultrasonic energy to advance viscosity of the mixture to a gel prior to the step of applying energy to initiate ROMP.

In an embodiment, the method further comprises infusing the mixture into a scaffold. For example, the scaffold may be a continuous or chopped material selected from the group consisting of carbon fiber, e-glass, s-glass, basalt, thermoplastic, aramid, polyolefin, natural or wood fiber, felt, cotton, woven blends thereof or a combination thereof.

In an aspect, the disclosed compositions can be used to repair, reinforce or protect objects by:
i) infusing the composition into a reinforcing fiber, wrapping the infused fiber around the area to be repaired, reinforced, or protected, and curing the composition via ROMP and/or FROMP or
Ii) applying the composition as a coating to the inside or outside of a buried, excavated, or new pipeline or hollow cylinder, followed by curing by ROMP and/or FROMP.

In an embodiment, the composition may be applied to a pipeline, cylinder or other object via spraying, pigging, painting, or extrusion.

In an embodiment, a method of coating an inner surface of a pipe comprises: providing a resin within the pipe, wherein the resin comprises at least one cyclic polyolefin susceptible to ring-opening metathesis polymerization (ROMP) or frontal-ring opening metathesis polymerization (FROMP); spreading the resin to coat one or more interior walls of the pipe; and applying energy to cure the resin, thereby forming a polymeric material. For example, spreading the resin may be selected from the group consisting of: i) spraying the resin onto the inner surface of the pipe; ii) dragging a pig along a length of the pipe; iii) extruding the resin; or iv) a combination of i), ii) and/or iii).

In an embodiment, the inner surface of the pipe has a round, oval, hexagonal, square, or irregular cross-section. Exemplary pipes may be metal (e.g., stainless steel), plastic (e.g., HDPE, PVC, PEX) or a combination thereof. In some implementations, the pipe is buried underground throughout the entire coating and curing process. In other implementations, the pipe is partially or completely above ground during all or part of the coating and curing process.

In an embodiment, the step of applying energy is selected from the group consisting of applying a point heat source to one or more areas of the resin, applying UV light to a portion of the resin, blowing warm air on a portion of the resin, or applying steam or heated water on a portion of the resin.

In an embodiment, the cyclic polyolefin is a strained cyclic olefin capable of ring-opening metathesis polymerization.

In an embodiment, the polymeric material is poly-dicyclopentadiene poly(DCPD), poly-norbornene, poly-cyclooctadiene, or combinations thereof.

In an embodiment, a resin used to coat the inner surface of a pipe comprises a latent pre-catalyst.

In an embodiment, the latent pre-catalyst is a precious metal (e.g., ruthenium) catalyst.

In an embodiment, the latent pre-catalyst is a Hoveyda-Grubbs catalyst.

### BRIEF DESCRIPTION OF THE DRAWINGS

Illustrative embodiments of the present invention are described in detail below with reference to the attached drawings.

FIG. 1 depicts an underground pipe having a steel outer shell with leaks and degradation due to corrosion.

FIG. 2 is a schematic of catalyst mixing into polymeric resin.

FIG. 3 shows an underground pipe coated with a continuous layer of a first polymeric material that is delivered by a robotic delivery system. A first method of initiating curing is shown.

FIG. 4 shows an underground pipe coated with a continuous layer of second polymeric material moving in a horizontal direction that is delivered by a robotic delivery system. A second method of initiating curing is shown.

FIG. 5 shows the effect of carbon black on the cure velocity of poly(DCPD).

FIG. 6 shows the effect of anatase phase of titanium dioxide on the cure velocity of poly(DCPD).

FIG. 7 shows the effect of cerium oxide on the cure velocity of poly(DCPD).

FIG. 8 is a method for deploying the coating of the disclosure.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

As used herein, a “latent pre-catalyst” or “latent catalyst” refers to a molecule lacking catalytic activity until it is converted into an active catalyst by exposure to an external stimulus. The active catalyst is typically i) the latent pre-catalyst molecule in a different configuration, ii) the latent pre-catalyst molecule minus a ligand, iii) the latent catalyst molecule plus a ligand, or iv) a combination thereof.

As used herein, a “moiety” is a part of a molecule.

As used herein, a “composite” comprises multiple parts or substances joined in a heterogenous configuration. Composites disclosed herein comprise a polymer and at least one other material (a scaffold). For example, the polymer may be layered with the other material, used to interpenetrate and/or encapsulate the other material, encapsulated by the other material, or otherwise intermingled with the other material.

“Proximal” and “distal” refer to the relative positions of two or more objects, planes or surfaces. For example, an object that is closer in space to a reference point relative to the position of another object is considered proximal to the reference point, whereas an object that is further away in space from a reference point relative to the position of another object is considered distal to the reference point.

The terms “direct and indirect” describe the actions or physical positions of one object relative to another object. For example, an object that “directly” acts upon or touches another object does so without intervention from an intermediary. Contrarily, an object that “indirectly” acts upon or touches another object does so through an intermediary (e.g., a third component).

As used herein, a “resin” refers to a mixture that comprises at least one pre-catalyst, monomers or oligomers, and/or solvent(s).

Advantages of the compositions and methods disclosed herein include, but are not limited to:
latent pre-catalysts that are simple to produce (e.g., by mixing or grinding); and
resin compositions that can be:
   used to make cured-in-place, sprayed-in-place, pigged-in-place or extruded-in-place liners for pipes;
   polymerized into conformal or other coatings comprised of resin alone or in a scaffold having thicknesses as small as 0.5 mm;
   formed as prepreg, which can be cut without breaking and laid-up while frozen;
      frontally polymerized in composite form;
      polymerized in humid environments or even underwater;
      polymerized from multiple directions simultaneously without introducing defects;
      used to renew pipes via external and/or internal application of the resin alone or in a scaffold;
      fully polymerized in minutes using simple tooling available from hardware stores and similar vendors;
      packaged into pre-measured, easy to mix cartridges and kits;
      adhered to metal, wood, concrete, clay, or mortar surfaces with proper surface preparation and/or chemical pretreatment;
      pigmented to match the color of the surface the resin is applied to;
      refrigerated for 3-90 days prior to cure; and
      partially polymerized, shaped and subsequently fully hardened.
         Polymerizing Resin and Methods for Internal and/or External Pipeline Coating

Thermoset or thermoplastic resins capable of frontal polymerization for pipe coating or liners include, but are not limited to, polyolefins, epoxies, methacrylates, polyureas/polyurethanes, polyesters, and combinations thereof.

Dicyclopentadiene-based polymeric materials are used for repair and rehabilitation of pipelines. The disclosed compositions and methods are utilized to repair the inner annular surface of existing pipelines by spraying, pigging, or extrusion of dicyclopentadiene and mixtures thereof. The polymeric material deposited on the inner annular surfaces is cured by ring-opening metathesis polymerization.

This Example relates to pipes used for gas or water distribution constructed from metal or plastic and, in particular, to methods for rehabilitating these pipes with a polymeric material. More specifically, the Example relates to methods and materials used for the delivery, extrusion and curing of thermosetting polymeric materials that can be used in the repair of a pipe.

Gas pipelines are typically constructed of steel and may or may not have a corrosion protective coating, such as paint, applied when they are placed into service. After many years of service, the steel is subject to corrosion, and subsequently, the formation of holes in the walls of the pipes. Replacement of the pipe with a new pipe can be extremely expensive, especially when it occurs in urban and suburban areas. Thus, there is a need for rehabilitating steel pipes in place.

Cured-in-place pipe (CIPP) liners are pipe liners used to repair damaged pipelines. Except for common sizes, this method uses a fabric liner that is made specifically for each pipe. Smaller diameter pipes may result from the use of “off the shelf” pipe liners. A disadvantage of using a smaller diameter “off the shelf” pipe whose diameter is smaller than the diameter to the host pipe to be lined is a much-reduced cross-sectional diameter in the rehabilitated host pipe. The smaller diameter reduces the flow capacity or increases the internal pressure to meet the required flow. Also, using “off the shelf” HDPE, PVC or similar materials as a liner material limits the owner, operator, and contractor from doing custom fit installations for the wide variety of host pipe diameters, loading conditions and compositions in the field.

An additional disadvantage of “off the shelf” core cylinders is the limited scope of materials. Most current systems use HDPE or PVC for their core cylinder material, i.e., the material in contact with pipeline media. While these current systems are constrained to the use of HDPE, PVC or similar premanufactured pipe materials, and fiber reinforced polymers (FRPs), there are many applications that are much better suited for specialized materials with higher strength materials such as dicyclopentadiene (DCPD).

CIPP fabric liners are either pulled into place and then coated with resin or inserted into a pipe already impregnated with resin. Ultraviolet (UV) light or heat are used to cure. Corners may cause wrinkles in the fabric and service connections must be restored by a robotic device. (Wood, U.S. Pat. No. 4,009,063). Curing may take up to 30 hours and custom fabric sleeves may be expensive.

Spiral wound strips of PVC or HDPE can be used to restore gravity pipelines. Strips of PVC, steel reinforced PVC, or HDPE located on spools above ground are typically fed to a winding machine. The winding machine rotates and causes the edges of the profile strips to interlock. The interlocking strips form a water-tight liner. Rotational action advances the liner through the host pipe. In smaller diameter pipes, the liner can be expanded by the winding machine to form a tight fit with the host pipe. Alternatively, a fixed diameter, field-fabricated liner can be installed, and the annular space between the host pipe and liner grouted.

Service connections are located by measurement and reinstated after lining. Grouting of the annular space is generally preferred to lock the liner in place. This effectively transfers external loads from the existing pipe onto the liner. Certain systems or nominal dimensions require temporary shaft reconstruction to allow for the equipment access, i.e., winding machine.

Many existing core cylinder practices are constrained not only by the type of material, but by the size and geometry of available components. For example, systems that employ fiber reinforced polymers (FRP) are typically limited to 12-inch diameter pipes. The Thermo-Flex system is further constrained to 8-inch diameter pipes, due both to bending limitations for storing larger pipes on spools, and inefficiencies in winding larger diameter pipes on spools. The Smart-Pipe system, which utilizes HDPE, confronts weight and size constraints from its manufacturing process for pipes larger than 12 inches.

While HDPE is a universal core material, it suffers from a lack of strength necessary to contain the internal pressures typically required in the energy media transmission or for large diameters in the municipal sector. While the installation of unreinforced HDPE or PVC will stop existing leaks and potentially mitigate continuing internal corrosion in the pipeline, its use as a renewal or repair method decreases the pipeline's maximum allowable operating pressure (MAOP). This required reduction in MAOP causes a derating of the pipeline system by regulatory authorities, thus significantly reducing the pipeline's output due to the associated decrease in total flow of media. This required reduction in flow has a severe impact on the financial efficacy of the pipeline for its owner/operator as well as disrupting customer supplies. Thus, the availability of a higher strength, more durable material of construction such as dicyclopentadiene is needed.

Again, current technologies use a core plastic cylinder (prefabricated pipe) for both buckling resistance (soil load, hydrostatic load, highway load & vacuum) and for resistance to internal pressure (hoop, radial or circumferential). Understandably, pipes with higher strength requirements also require the wall of the core cylinder to be thicker.

Considering both the low hoop strength and the low modulus of HDPE, as compared to dicyclopentadiene, the wall thickness of HDPE must be thicker to obtain an equal hoop strength. Additionally, due to the low softening point of polyethylene in applications where heated media is transmitted, this wall thickness increases exponentially. This required increase in thickness has several disadvantages. First, an increased thickness results in the lining system being of higher weight per linear foot, thus resulting in reduced lengths it can be pulled into the existing host pipe without tension and/or friction related damage. Secondly, an increase in material thickness directly decreases the flexibility of the current lining systems. This decrease in flexibility impedes the lining system's ability to traverse undulations (sags or protrusions) and to traverse through even minor bends in the pipeline.

There are currently known compositions of remotely sprayed-in-place (SIPP) systems and other spray applied renewal systems that provide improved properties and/or repair of degraded or damaged pipelines already in use. There are many drawbacks to the use of such materials and methodologies for both transmission and distribution pipeline systems. The first of these system issues is that they do not meet the requirements of a Class IV fully structural lining for pressure pipe per the AWWA M28 Structural Classifications. Current spray applied systems do not possess auxiliary axial or hoop reinforcement and rely on the spray applied material solely to provide resistance to both axial and radial loading from internal pressure. Without auxiliary reinforcement, such as axial reinforcement fibers, bi-directional fabric and/or radially wound filament, the spray applied material must resist all hoop stresses created by the internal pressure of the media as well as resisting the creep effect of being subjected to constant strain, thus reducing the long-term retention of physical properties through fatigue.

Thus, a pipeline rehabilitation system must overcome the disadvantages of the prior art and be able to repair pipes in vertical and horizontal directions.

Advantages of the present compositions and methods will be evident to those skilled in the art. A novel method and material for rehabilitation of pipelines has been developed. In some embodiments, a polymeric mixture is activated and polymerized by a frontal polymerization, a ring-opening metathesis polymerization (ROMP), or a frontal ring-opening metathesis polymerization (FROMP) reaction mechanism.

Dicyclopentadiene is employed in numerous industrial applications that require structurally robust, high strength materials. Traditional curing methods involve long heating times and are limited by the size of the available ovens or autoclaves. Frontal ring-opening metathesis polymerization (FROMP) provides a solution to curing long stretches of underground piping without additional equipment and power needed. An initial thermal or photoinitiated stimulus initiates FROMP and, once initiated, the reaction is self-sustaining. The heat released from the catalytic ring opening of highly strained olefin monomers triggers subsequent curing of the polymeric resin. The net result is that a reaction zone traverses through the monomer resin with a measurable velocity and a well-defined monomer-to-polymer interface.

Methods and compositions are disclosed for delivery and placement of an uncured polymeric material that, in one operation, can be cured and can provide a coating that protects, prevents corrosion, and/or reduces or eliminates the leakage of gas from the interior and/or exterior of gas pipelines, valves, and fittings.

Spatially relevant terms such as beneath, below, above, upper, upstream, downstream and similar phrases may be used herein to describe the relationship of one element to another element. Further, even though a figure may depict a horizontal pipe or a vertical pipe, unless indicated otherwise, it should be understood by those skilled in the art that the apparatus is equally well-suited to other orientations and other geometries such as angled (45 degree) bends, split pipes (such as “Y” and “T” construction).

For purposes of this disclosure, the terms polymeric resin and polymeric material refer to a material capable of being extruded and cured into a material suitable for structural applications.

Disclosed herein are embodiments of a curing method that allow for the formation of a high strength annular shell within a first chamber or annular cavity. A second annular shell may be formed by spraying or extruding a polymeric material through a nozzle that is moving horizontally or vertically through the pipe. The polymeric material may also be spread into a coating by a pig. The polymeric material being extruded contains a catalyst and a resin. Upon application of a curing mechanism, the catalyst reacts with a resin and begins to harden and retain the shape of the inner annular shell.

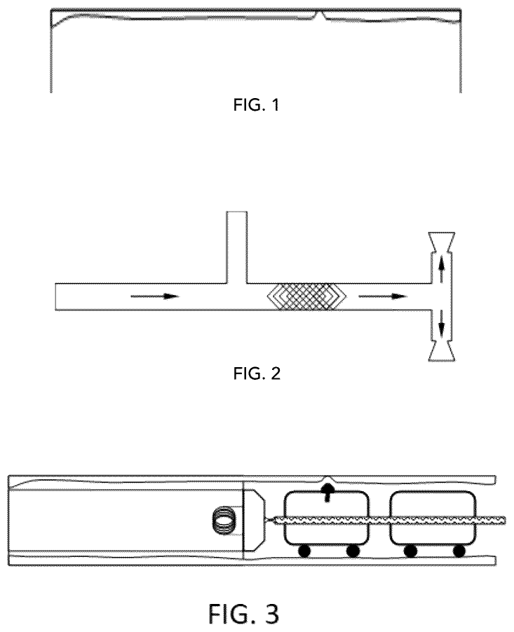

With regard to the drawings, FIG. 1 shows a cross-sectional view of an underground pipe with damage due to corrosion.

FIG. 2 is an example of a method of mixing catalyst and resin and extrusion through a nozzle. Catalyst is mixed with resin and then the mixture is extruded through a nozzle and dispersed on the inside of an existing pipe surface. FIG. 3 is a schematic of an extruded annular shell of a first polymeric material being placed inside a pipe and a method of curing the polymer material that is initiated by resistance heating of a filament.

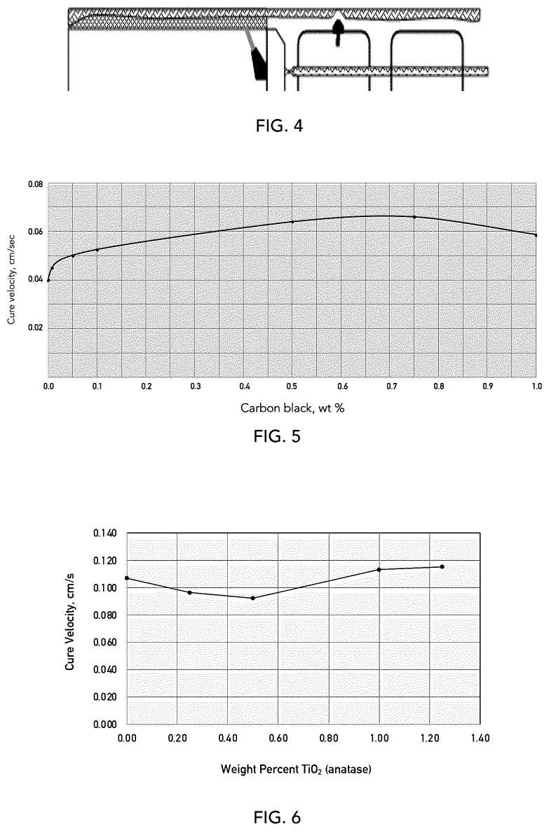

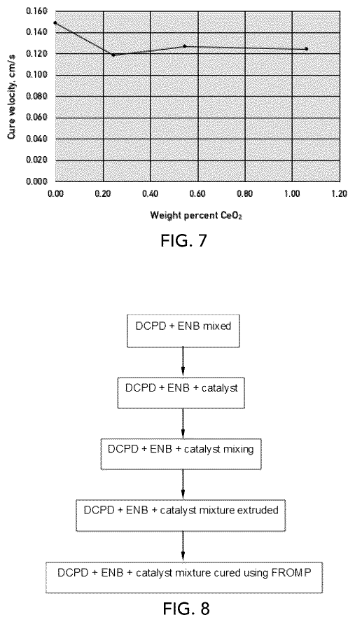

FIG. 4 is a cross-sectional view of the extrusion process that results in the formation of an inner annular shape on the surface of the existing pipe. A nozzle allows a polymeric material to be extruded evenly across the surface of the annular section. The deposited polymeric material is a viscous liquid that adheres to the wall. A catalyst is injected into the polymeric resin and mixed therewith as it is extruded toward the nozzle. Mixing may be accomplished by static inline mixing or by a dynamic pumping action. Curing the polymer material may be initiated by a light source. Said light source may be an LED, UV lamp, laser or other light source.

In FIG. 4 conveyance of the robotic delivery system is accomplished by a robotic delivery vehicle to which the nozzle, catalyst injection hardware, and mixing apparatus is attached. The robot is attached to a surface platform via a tether or cable. A cable or tether may supply electric power, catalyst, polymer resin and curing apparatus. The polymer resin is capable of being cured into a hard, durable solid that conforms to the inner surface of the outer annulus.

In an alternate embodiment, a second robotic-controlled vehicle is attached to the first vehicle and is used as a source for polymeric material. The current method is not limited by the design or number of robotic delivery vehicles.

A complete robotic delivery system may be generally characterized as having a tubing system, fluid handling and distribution system and device for curing polymeric resin. For purposes of this disclosure, a complete robotic delivery system may include robots, nozzle, heat source, polymeric material, mixing devices, catalysts, reservoirs, power cables, batteries, lighting, sensors, and any other pipes or equipment that is connected or associated with the foregoing.

As the robot travels through the pipe an annulus of extruded polymeric material is formed between the walls of the inner pipe diameter and the extruded pipe. Frontal ring-opening metathesis polymerization of the resin in FIG. 4 is accomplished by either a heat source, such as an electrical filament, or by a laser whose light beam is directed to the wall of the pipe, or by any other source that is capable of curing an uncured polymer. The polymeric material shown in FIG. 3 does not contain any additional materials such as photosensitizers that will absorb the energy from a laser beam and that will initiate frontal ring-opening metathesis polymerization (FROMP). FROMP can be modified by the use of additions to the catalyst. For instance, 2,3-dihydrofuran (DHF) can be added to the catalyst to delay the onset of polymerization.

FIG. 4 depicts the same assembly as shown in FIG. 3, however, the annulus of a second polymeric material contains a material that absorbs light energy and can be cured using heat generated by the application of a laser beam. The curing mechanism, in this case a laser beam, heats the surface of the polymer and initiates polymerization by a frontal ring-opening metathesis polymerization reaction.

In one or more embodiments, a second annular shell has a circular cross section about a primary axis. In one or more embodiments, the shell may be formed by extrusion of a viscous polymeric compound through a nozzle. The annular shell is approximately the same thickness at all points in FIG. 4. In one or more embodiments, the shell may be formed of dicyclopentadiene (DCPD), a solvent such as 5-ethylidene-2-norbornene (ENB), a precious metal catalyst and other additives that enable the proper rheological and mechanical properties and which are curable using a FROMP reaction. ENB may be present in amounts between 5 and 25 weight percent.

Other additives include substances which alter the rheological properties of dicyclopentadiene. These agents include a block copolymer with molecular weight between 100,000 and 500,000 Dalton. One such copolymer is styrene-butadiene-styrene (SBS) with molecular weight of approximately 160-180 kDa. Additions of styrene-butadiene-styrene are generally between 0 and 5 weight percent. A typical amount of SBS is 2 weight percent.

Other additions include rheological modifying agents such as fumed silica. Different levels of hydrophilic fumed silica can be added to DCPD/ENB to increase its viscosity. The commercial fumed silica known as Aerosil 200 is used to increase the viscosity of the polymeric resin to approximately 2000 centipoise. Typical ranges of fumed silica are between 5 and 7 weight percent.

2,3-Dihydrofuran may also be added to the resin. Their purpose is to extend the pot life or working time of the resin once catalyst has been added. Typically, one mole percent of DHF is added, but larger or smaller amounts may be used.

Catalyst mixtures are formulated separately from the resin. Catalysts are comprised of a ruthenium-based Grubbs catalyst, a diluent such as mineral oil, and a rheology modifier such as a Aerosil R805. Aerosil R805 is a hydrophobic fumed silica. 2,3-Dihydrofuran is an optional component of the catalyst suspension.

US 2022/0363784 to Leguizamon, et al., describes additional catalyst and resin systems. Further modifications to the catalyst are described by Suslick (Macromolecules, 2022, 55, 5459-5473) that allow catalysts to survive for extended periods of time. These catalysts are incorporated herein by reference.

For purposes of this disclosure, the term “base material” is considered to be comprised of DCDP, ENB, SBS, catalyst mixtures and fumed silica. Any further additions to the “base material” are called additives. For instance, carbon black, graphite, carbon nanotubes, etc. are considered additives to the base material.

Levels of carbon in the form of carbon nanotubes, graphite, carbon black, black glass powder or mixtures thereof, may be present in amounts between 0.005 weight percent and 2 weight percent. A typical range is between 0.05 and 1.0 weight percent. Carbon black assists in the laser-induced FROMP reaction. Although not limited to a particular chemical composition, in one or more embodiments, the composition of FIG. 4 may contain carbon black, graphite, carbon fiber, carbon nanotubes, black glass powder, graphene, or mixtures thereof. These studies were generally completed with 1 weight percent of carbon black.

While the extruded region is generally shown as a singular annular structure in the shape of a cylinder, it may be formed in a non-circular cross section and in various thicknesses. Likewise, it may be a first thickness for a specific length and then a second thickness for a second length. Regardless of the geometry and thickness employed, all compositions of polymeric material are capable of ring-opening metathesis polymerization (ROMP) or frontal ring-opening metathesis polymerization (FROMP). Additions of carbon black may improve surface smoothness and assist in the reaction.

Alternatively, other additions have been tested that allow FROMP and laser curing. These additives include titanium dioxide. Titanium dioxide additions to the base material impart a white color to the polymeric material and are useful additives that allow the curing to occur by laser initiation. Levels of titanium dioxide may be between 0.1 weight percent and 2 weight percent. Titanium dioxide exists in two crystal forms, the anatase phase and the rutile phase. Oxygen-deficient titanium dioxide is known to exist; it is generally regarded as blue-TiO₂ and black-TiO₂. All four types of titanium dioxide are included within the present disclosure.

These additions may be included separately or together in the novel thermosetting resin described herein.

Other additions to the base material have been explored. These additions include cerium oxide and tungsten oxide in a nanopowder form. The influence of these additives on the cure velocity is given in Table 1.

TABLE 1
Effect of additions to the cure velocity of poly(DCPD).

| Material | Wt. % | Cure time, s | Cure velocity, cm/s | % |
|---|---|---|---|---|
| Carbon black | 0.0 | | 0.04 | 100% |
| | 0.01 | | 0.044 | 109% |
| | 0.05 | | 0.05 | 125% |
| | 0.10 | | 0.0536 | 134% |
| | 0.50 | | 0.064 | 159% |
| | 0.75 | | 0.067 | 168% |
| | 1.00 | | 0.058 | 144% |
| TiO₂ | 0.0 | 56.11 | 0.107 | 100% |
| | 0.25 | 62.30 | 0.096 | 90% |
| | 0.50 | 65.06 | 0.092 | 86% |
| | 1.0 | 53.02 | 0.113 | 106% |
| | 1.25 | 52.12 | 0.115 | 108% |
| CeO₂ | 0.0 | 40.43 | 0.148 | 100% |
| | 0.245 | 50.77 | 0.118 | 80% |
| | 0.546 | 47.28 | 0.127 | 86% |
| | 1.06 | 48.33 | 0.124 | 84% |

The novel pipe rehabilitation material described herein is stronger than HDPE and PVC. It is continuously extruded onto an inner annular surface and does not contain welded joints. A novel curing method is described. Table 2 gives mechanical properties of materials commonly used to rehabilitate underground pipes.

TABLE 2
Mechanical properties of DCPD and other polymeric materials.

| | Yield | Tensile | | |
|---|---|---|---|---|
| | strength, | strength, | Elongation, | Modulus of |
| Material | MPa | MPa | % | Elasticity |
| Neat DPCD | | 54.2 | 22% | 2.08 |
| PVC | 23 | 42 | 5.3% | 2.80 |
| HDPE | 20 | 45 | 9.4% | 1.75 |
| This invention | | 48 | 11% | |

The current compositions and methods overcome the limitations of the prior art. DCPD has superior mechanical properties compared to HDPE and PVC. The robotic delivery system allows fabrication in several different geometric configurations that overcome limitations of the prior art. The improvements include:
1. Thickness of DCPD can be changed as needed
2. Corners can be coated evenly
3. Ovality can be accommodated without special fixtures or attachments
4. Fits flush to the wall
5. Modifications to the formulation allow for different strength and elongation values
6. Fully structural, does not need support liners.

Thermosetting compounds may include DCPD, ENB, and other compounds capable of FROMP. In US 2022/0363784, Leguizamon, et al., discuss alternate catalysts and photosensitizers that are capable of initiating frontal ring-opening metathesis polymerization. Photosensitizers are incorporated herein by reference. In one or more embodiments, additive particulates such as plasticizers, fillers, or fibers may be suspended in or otherwise mixed with the polymeric compounds to achieve the desired chemical reaction, processing or final properties. The particulates may be selected based on the need to control rheological properties of the polymeric material, or they may be chosen for their desirable influence on mechanical or thermal properties. For instance, a fiber may be added that enhances the mechanical properties of the polymeric material. In some embodiments, particulates may be comprised of glass, carbon fiber, carbon black, graphite, graphene, carbon nanotubes, wollastonite or any combinations thereof that enhance the optical properties of the polymeric compound. In another embodiment, particulates of titanium dioxide are added to the polymeric resin. Advantages of these particulates may include the ability to reduce void formation, improve surface smoothness, reduce thermal expansion, improve tensile strength, and control volumetric expansion or contraction upon polymerization.

Microencapsulation is a technique through which liquid materials, either aqueous or non-aqueous in nature, are encapsulated within a solid shell. The nature of shell wall materials is a function of the material to be encapsulated and the coating application process. In one aspect, the addition of microcapsules to the base resin provides an autonomic self-indicating, self-healing and/or self-protecting polymer material having a plurality of capsules dispersed therein. The capsules having an indicating, healing and/or protecting agent encapsulated therein and at least one layer of a shell wall coated composed of urea/formaldehyde, where the self-indicating, self-healing and/or self-protecting process can be initiated when a region of the polymer material has been sufficiently damaged so as to rupture one or more capsules, which thereby releases the indicating, healing and/or protecting agent in the damaged region. In the compositions a total of 7.5 weight percent of self-healing and 7.5 weight percent of self-reporting microcapsules were added to the polymeric material. The catalyst microcapsules have a urea-formaldehyde shell that contains a mixture of phenylcyclohexane (PCH) and catalyst within the shell. Monomer microcapsules are comprised of a urea-formaldehyde/silica exterior shell and an interior comprised of DCPD/PCH (95/5 wt %), copper (I) chloride, and an antioxidant (IONOX; 2 weight percent).

Other modifications of the polymeric material will be evident to those skilled in the art. The following examples are given to illustrate the preparation of the polymeric compound used.

### Example 1

Example 1 describes the preparation of 15.45 grams of polymeric resin. 14.25 grams of solid dicyclopentadiene (DCPD) are placed into an oven held at 40° C. or greater until melted. 0.75 grams of 5-ethylidene-2-norbornene (ENB) are added to the mixture and stirred by hand. In a second vial, 9.63 milligrams of precious metal catalyst, 84 milligrams of 2,3 dihydrofuran, 0.45 g of mineral oil and 9 milligrams of Aerosil R805 are sonicated for 15 minutes. The vial is closed and sonicated for five minutes until the precious metal catalyst is dissolved. The 15 grams of prepared DCPD/ENB resin is transferred into a graduated sample cup. The solution is placed into a vacuum chamber, uncovered, and degassed at about −685 Torr (−27 inches Hg) until bubbles stop forming.

### Example 2

Example 2 describes the preparation of 16.35 grams of polymeric resin. 14.25 grams of solid dicyclopentadiene (DCPD) are placed into an oven held at 40° C. or greater until melted. 0.75 grams of 5-ethylidene-2-norbornene (ENB) are added to the mixture and stirred by hand. In a second vial, 9.63 milligrams of precious metal catalyst, 84 milligrams of 2,3 dihydrofuran, 0.45 gram of mineral oil and 9 milligrams of Aerosil R805 are sonicated for 15 minutes. The vial is closed and sonicated for five minutes until the precious metal catalyst is dissolved. The 15 grams of prepared DCPD/ENB resin is transferred into a graduated sample cup. The solution is placed into a vacuum chamber, uncovered, and degassed at about −685 Torr (−27 inches Hg) until bubbles stop forming.

0.90 gram of fumed silica is added into a graduated sample cup. The degassed solution is poured onto the fumed silica using a Pasteur pipette to ensure all is transferred. The sample cup is closed and placed in a planetary mixer and mixed at 2000 rpm for one minute. The mixed solution is placed back into a vacuum chamber, uncovered, and degassed again under vacuum at about −685 Torr (−27 inches Hg) until bubbles stop forming.

### Example 3

Example 3 describes the preparation of 16.5 grams of polymeric resin. 14.25 grams of solid dicyclopentadiene (DCPD) are placed into an oven held at 40° C. or greater until melted. 0.75 grams of 5-ethylidene-2-norbornene (ENB) are added to the mixture and stirred by hand. In a second vial, 9.63 milligrams of precious metal catalyst, 84 milligrams of 2,3 dihydrofuran, 0.45 gram of mineral oil and 9 milligrams of Aerosil R805 are sonicated for 15 minutes. The vial is closed and sonicated for five minutes until the precious metal catalyst is dissolved. The 15 grams of prepared DCPD/ENB resin is transferred into a graduated sample cup. The solution is placed into a vacuum chamber, uncovered, and degassed at about −685 Torr (−27 inches Hg) until bubbles stop forming.

0.90 gram of fumed silica is added into a graduated sample cup. The degassed solution is poured onto the fumed silica using a Pasteur pipette to ensure all is transferred. The sample cup is closed and placed in a planetary mixer and mixed at 2000 rpm for one minute. The mixed solution is placed back into a vacuum chamber, uncovered, and degassed again under vacuum at about −685 Torr (−27 inches Hg) until bubbles stop forming. After 0.15 grams of carbon black is added to the mixture, it is thoroughly mixed in a planetary mixer.

### Example 4

Example 4 describes the preparation of 16.5 grams of polymeric resin. 14.25 grams of solid dicyclopentadiene (DCPD) are placed into an oven held at 40° C. or greater until melted. 0.75 grams of 5-ethylidene-2-norbornene (ENB) are added to the mixture and stirred by hand. In a second vial, 9.63 milligrams of precious metal catalyst, 84 milligrams of 2,3 dihydrofuran, 0.45 gram of mineral oil and 9 milligrams of Aerosil R805 are sonicated for 15 minutes. The vial is closed and sonicated for five minutes until the precious metal catalyst is dissolved. The 15 grams of prepared DCPD/ENB resin is transferred into a graduated sample cup. The solution is placed into a vacuum chamber, uncovered, and degassed at about −685 Torr (−27 inches Hg) until bubbles stop forming.

0.90 gram of fumed silica is added into a graduated sample cup. The degassed solution is poured onto the fumed silica using a Pasteur pipette to ensure all is transferred. The sample cup is closed and placed in a planetary mixer and mixed at 2000 rpm for one minute. The mixed solution is placed back into a vacuum chamber, uncovered, and degassed again under vacuum at about −685 Torr (−27 inches Hg) until bubbles stop forming. To this mixture, 0.15 gram of carbon black, 1.24 gram of self-healing microcapsules and 1.24 gram of self-reporting microcapsules are added and the mixture is then thoroughly mixed in a planetary mixer.

Table 3 gives the formulation of the dicyclopentadiene/norbornene component of the polymeric material without self-healing or self-reporting microcapsules.

TABLE 3

| Component | Amount | | Relative to |
|---|---|---|---|
| Dicyclopentadiene | 95 | wt % | |
| 5-ethylidene-2-norbornene | 5 | wt % | |
| Aerosil 200 (200 m²/g) fumed | 5.5 | wt % | DCPD/ENB mass |
| silica | | | |
| 2,3 dihydrofuran | 1 | mole % | DCPD/ENB mass |
| SBS block copolymer* | 2 | wt % | DCPD/ENB mass |
| Carbon black | 0.10 | wt % | DCPD/ENB mass |

*polystyrene-block-polybutadiene-block-polystyrene

Table 4 gives the formulation of the catalyst.

TABLE 4

| | | |
|---|---|---|
| Component | Amount | Relative to |

| | | |
|---|---|---|
| Mineral oil | 97.97 | wt % |
| Grubbs catalyst M204 | 0.02587 | wt % |
| Aerosil R805 fumed silica | 2 | wt % |

| | | |
|---|---|---|
| 2,3 dihydrofuran | 38.66 × Grubbs | Grubbs |
| | | catalyst |

FIG. 5 illustrates a method for deploying an underground pipeline rehabilitation system. In a first step, a resin, DCPD, is melted and mixed with a solvent, ENB, and any other additives other than the catalyst.

In step 2, the catalyst is added to the polymeric mixture.

In step 3, the catalyst and polymer are thoroughly mixed in a mixing apparatus located within the tube containing the DCPD, ENB, and any other additives as shown in FIG. 2.

In step 4, the polymeric material and catalyst mixture are transported to a nozzle where they are extruded into a generally annular shape. Other geometries are also considered, as previously mentioned. An external force supplied by the robot is used to extrude the polymeric material. The polymer is expanded or pushed into contact with the adjacent first annular surface with which a seal is desired, as the robot delivery device travels in the opposite direction. As the polymeric material is extruded it expands radially outward to the first annular surface until it engages the inner surface of the pipe. The nozzle(s) may rotate, articulate, vibrate or otherwise move in a way that produces a uniform coating on the inner annular surface of a pipe.

In an embodiment, the external force needed for extrusion is supplied by electrical energy in the form of a motor and pump such as a gear pump. In an embodiment, the external force needed for extrusion is supplied by hydraulically activating a piston or sleeve to propel the polymeric material through the nozzle. In an embodiment, a mechanical force may be used as an external force to propel the polymeric material from the nozzle onto the sealing surface. In an embodiment, pneumatic pressure is used to force polymeric material through a nozzle. In any event, the polymeric material is extruded from the robot into a hose and plastically deformed as it is applied to the pipe and forms a seal therebetween.

In step 5, a method of initiating the curing reaction, FROMP, is provided. Curing occurs as the fluid deposited within the inner annulus is contacted with a heat source. Said heat source can be applied to polymeric material by either direct contact of heated component or by indirect contact, such as by a laser beam pointed at the polymeric material. Other methods of polymer initiation are possible.

Upon application of an external curing mechanism, the intermixed fluids react and begin to cure. The polymeric compound is thus hardened into a rigid body capable of self-support. Hardening occurs by frontal ring-opening metathesis polymerization. Polymerization occurs in a planar fashion as opposed to a homogeneous event in normal polymerization reactions.

In step 5, there are no external forces required to maintain the deformed shape of the inner annular shape as it cures and hardens. The nozzle assembly as described is desirable because it can be applied over a wide variety of cross-sectional areas and will form a hardened polymeric coating that is capable of rehabilitating gas pipelines. The present disclosure is not limited in scope to gas pipelines only, but may also be used for pipelines containing hydrogen, water, oil or mixtures thereof.

Thus, a rehabilitation material and method of delivery have been described. The rehabilitation material may include a polymeric shell that is extruded onto a first annular shape and forms a shell thereon. A method of mixing a catalyst and initiating a hardening or curing reaction is provided and a second annular shape is formed on the first annular shape. Thus, a robotic tool necessary for the deposition of a polymeric shell material has been described. The underground tool may include a robot, an external power supply, a nozzle, mixing units, and other cables and tethers necessary to mix, extrude and cure a polymeric material such that the polymeric shell produced is parallel to the axis of the underground pipe.

### Pre-Curing Resin Gelation

For some applications, it is desirable to induce gelling of the resin prior to initiating ROMP or FROMP. Gelling may be induced, for example, by pre-warming the resin, such as by warming an object that the resin is applied to through use of a heated blanket or heat gun, blowing warm air, or applying UV light. Without being bound to a particular theory, it is believed that pre-warming the resin induces oligomerization that provides allows for rapid, but less “violent”, polymerization. For example, a gelled resin may be cured from multiple FROMP initiation locations without inducing mechanical/structural defects, such as ridges where polymerization fronts meet.

### FROMP in Composite Materials

Previously reported FROMP reactions in composite materials have suffered from a lack of curing at fiber-resin interfaces and/or impedance of wavefront propagation by the scaffold material. However, the presently disclosed compositions and methods overcome these practical disadvantages likely due to the chemical reactivity invoked by the pre-catalyst/catalyst and the ability for the resin compositions to transfer energy.

In an embodiment, gelation of resin that is infused into a scaffold facilitates FROMP with complete curing and full propagation.

### High Humidity and Underwater Polymerization

Prior to development of the presently disclosed latent pre-catalysts, resin compositions and methods there were no reports of ROMP or FROMP manufacturing in environments where the relative humidity was 80% or greater. In contrast, the resin systems disclosed herein cure upon application of heat and/or UV-light when completely submerged in water.

### Example 5

Example 5 describes underwater polymerization. 200 g of resin, containing GC2 (100 ppm), phenol/benezediol (1.5 eq.), aryl phosphite (1 eq.), DCPD and solvent, was mixed and pipetted into a glass jar of water, where it coalesced into one uniform layer floating on top of the water. The cure was initiated with a soldering iron touched to the outside of the jar. The soldering iron was removed once the reaction was initiated. FROMP was visually apparent as waves emanated from the point of heat initiation to the other side of the jar. The entire sample of liquid resin in the jar of water was crosslinked yielding a water-tight seal.

### Cold Storage of Resin and Prepreg

Resin comprising a latent pre-catalyst, a cycling polyolefin and an organic solvent is infused into a reinforcing fabric and stored at or below 25 C for 7 days or more while ROMP or FROMP activity is retained.

In some embodiments, refrigerated or frozen prepreg materials may be removed from cold storage and immediately cut without chipping, cracking or breaking. In their original or cut shape, the prepreg materials may be laid up in a desired configuration, and polymerized via ROMP or FROMP, thereby reducing manufacturing time and energy costs associated with warming stored materials prior to use.

Table 5 shows data for prepreg experiments in the refrigerator and freezer.

TABLE 5

| | | Tack | Resin | Time | | Tg |
|---|---|---|---|---|---|---|
| | Time | Level | Content | to Cure | | TanD |
| Location | (days) | (1-5) | % | (s) | Hardness | (C) |
| Fridge | 14 days | 2 on | 41.802% | 90 | 78.5-88.5 | 138 +/− 3 |
| (7-14 C.) | | top, | | | | |
| | | 3 on | | | | |
| | | bottom | | | | |
| | 55 days | 1 | 34.442% | 90 | 84-90 | TBD |
| Freezer | 14 days | 5 | 42.524% | 90 | 84-90.5 | 140 +/− 3 |
| (−4-−10 C.) | 55 days | 4 | 40.643% | 90 | 81.5-90 | TBD |

### REFERENCES

Vaisman, A. et al., J. Am. Chem. Soc., 2024, 146, 73-78.
U.S. Pat. No. 12,297,307, “3D printing of thermoset polymers and composites”.
WO2017053690A1, “Metal carbene olefin metathesis catalysts”; assignee Materia Inc.
WO2020123946A1, “Coating compositions”; assignee Materia Inc.
U.S. Pat. No. 10,487,446 B2, “Frontal polymerization for fiber-reinforced composites”.
U.S. Pat. No. 7,612,152 B2, “Self-healing polymers”.
Robertson, I.D. et al. Rapid energy-efficient manufacturing of polymers and composites via frontal polymerization. Nature (2018).
Robertson, I.D. et al. Alkyl Phosphite Inhibitors for Frontal Ring-Opening Metathesis Polymerization Greatly Increase Pot Life. ACS Macro Letters (2017).
Aw, J. E. et al. Self-Regulative Direct Ink Writing of Frontally Polymerizing Thermoset Polymers. Advanced Materials Technologies (2022).
Davydovich, O. et al. Encapsulated Transition Metal Catalysts Enable Long-term Stability in Frontal Polymerization Resins. Macromolecules (2023).

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps. All art-known functional equivalents of materials and methods are intended to be included in this disclosure. Nothing herein is to be construed as an admission that the invention is not entitled to antedate such disclosure by virtue of prior invention.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a” “an”, and “the” include plural reference unless the context clearly dictates otherwise. Thus, for example, reference to “a molecule” includes a plurality of such molecules and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements, limitation or limitations which is/are not specifically disclosed herein.

1. A latent pre-catalyst having the formula: 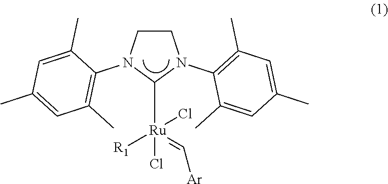
wherein R₁ is a phenoxy group optionally substituted with one or more substituents selected from —H, —OH, (1-6C)alkyl, halogen, thiol or nitro; and
Ar is an aryl group.

2. The latent pre-catalyst of claim 1, wherein R₁ is a radical of a phenol, a bisphenol, a benezediol, a catechol, eugenol, vanillin, butylated hydroxytoluene, (4-tert-butyl)phenol, (4-tert-butyl)catechol, 2,2′-dihydroxybiphenyl, 4-methylcatechol or a combination thereof.

3. The latent pre-catalyst of claim 1, wherein the Ar group is selected from the group consisting of phenyl or indenyl.

4. The latent pre-catalyst of claim 3, wherein the Ar group is optionally substituted with one or more substituents selected from (1-6C)alkoxyl, (1-6C)alkyl, aryl, (1-6C)alkylthio, halogen or nitro.

5. The latent pre-catalyst of claim 1, wherein the Ar group is optionally substituted with one or more substituents selected from (1-6C)alkoxyl, (1-6C)alkyl, aryl, (1-6C)alkylthio, halogen or nitro.

6. The latent pre-catalyst of claim 1 existing in the absence of a phosphite ligand.

7. The latent pre-catalyst of claim 1 in combination with a resin comprising a cyclic polyolefin susceptible to ring-opening metathesis polymerization (ROMP).

8. The latent pre-catalyst of claim 7, wherein the ROMP is frontal ring-opening metathesis polymerization (FROMP).

9. The latent pre-catalyst of claim 1 existing in the presence of an aryl phosphite selected from the group consisting of: 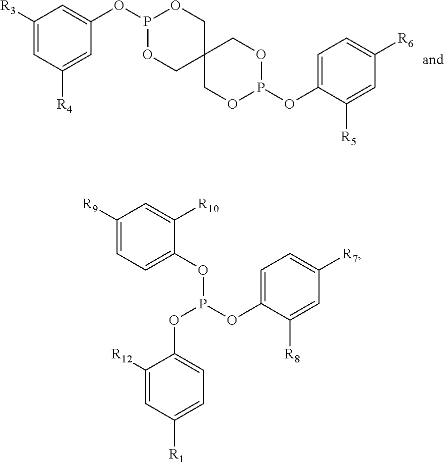
where R₃-R₁₂ are independently selected from —H and (1-10C)alkyl.

10. (canceled)

11. (canceled)

12. A method for synthesizing a polymer, the method comprising:
creating a mixture of the latent pre-catalyst of claim 1, an aryl phosphite, and a cyclic polyolefin; and
applying energy to the mixture to initiate ring-opening metathesis polymerization (ROMP).

13. The method of claim 12 further comprising discontinuing the step of applying energy after the ROMP is initiated.

14. The method of claim 12, wherein the latent pre-catalyst comprises 0.01-100 molar equivalents of R₁ ligand relative to ruthenium, the aryl phosphite is present at a concentration of 0.01-100 molar equivalents relative to ruthenium, and the latent pre-catalyst is present at a concentration between 0.00001-1 molar equivalents of the cyclic polyolefin.

15. (canceled)

16. (canceled)

17. (canceled)

18. (canceled)

19. The method of claim 12, wherein the aryl phosphite is selected from the group consisting of: 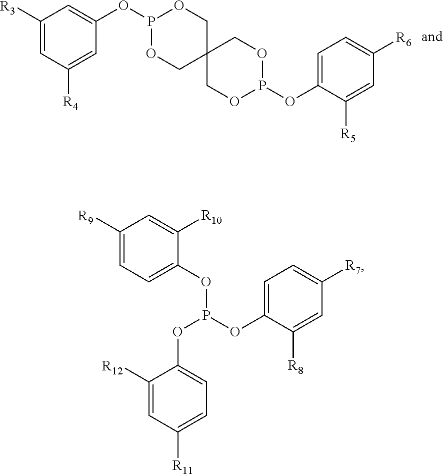
where R₃-R₁₂ are independently selected from —H and (1-10C)alkyl.

20. The method of claim 12, wherein the ROMP is a frontal ring-opening metathesis polymerization (FROMP) reaction.

21. The method of claim 20, wherein the FROMP propagates a self-sustaining exothermic polymerization wave with a frontal velocity between 0.02 and 0.5 centimeters per second.

22. (canceled)

23. (canceled)

24. The method of claim 12, wherein the cyclic polyolefin is selected from the group consisting of dicyclopentadiene, a substituted derivative of dicyclopentadiene, a cyclopentadiene oligomer of n=3 or greater, a norbornene, a substituted derivative of norbornene and a combination thereof.

25. The method of claim 12, wherein the step of applying energy is performed in an environment having a relative humidity of at least 80%.

26. (canceled)

27. (canceled)

28. The method of claim 12, where heat, electromagnetic radiation and/or ultrasonic energy is used to advance viscosity of the mixture to a gel prior to the step of applying energy to initiate ROMP.

29. The method of claim 12 further comprising infusing the mixture into a scaffold.

30. (canceled)

31. A method of coating an inner surface of a pipe, the method comprising:
providing a resin within the pipe, wherein the resin comprises at least one cyclic polyolefin susceptible to ring-opening metathesis polymerization (ROMP) or frontal-ring opening metathesis polymerization (FROMP);
spreading the resin to coat one or more interior walls of the pipe; and
applying energy to cure the resin, thereby forming a polymeric material.
